(19) United States
(12) Patent Application Publication
(10) Pub. No.: US 2019/0274030 A1
(43) Pub. Date: Sep. 5, 2019

(54) System and Method for Contact Information Exchange Using Ultrasonic Waves

(71) Applicant: Swishh, Inc., San Francisco, CA (US)

(72) Inventors: Frederic Bidot, San Francisco, CA (US); Kahlil Trocme, San Francisco, CA (US)

(21) Appl. No.: 15/911,339

(22) Filed: Mar. 5, 2018

(51) Int. Cl. H04W 8/20; H04W 4/21; H04L 29/08; H04M 1/725; H04B 11/00

(52) U.S. Cl. CPC H04W 8/205; H04W 4/21; H04B 11/00; H04M 1/72527; H04L 67/306

(57) ABSTRACT

A secure method of transferring profile data between computing devices, such as mobile telephones, utilizes ultrasonic waves having an ultrasonic codec that is transmitted from a transmitting computing device to a receiving computing device. This method may be utilized by computing devices made by different manufacturers and having different operating systems. Computing devices may be placed in proximity to each other to initiate the profile data transfer via ultrasonic waves. A transmitting mobile computing device may transmit the ultrasonic waves through a speaker on the mobile device or through an auxillary speaker. The receiving device may receive the ultrasonic codec through a microphone, such as on the mobile device or an auxiliary microphone. Each computing device may utilize an information exchanger software that enables the transfer of profile data through ultrasonic waves. A user may interace with the information exchanger software to transmit and/or receive profile information.

### FIELD OF THE INVENTION

The field of invention generally relates to a system and method for the transfer of user-specific profile data between electronic devices. More specifically, one or more embodiments provided in the present description relate to the transfer of user specific profile data, including, but not limited to, contact information particularly associated with the user such as email addresses, telephone numbers, and social media accounts using a mobile application having secure ultrasound transmission and reception between one or more devices.

### BACKGROUND

Meeting people and staying in touch is a still an essential part of human social interaction. People continue to interact for a variety of personal and professional reasons. Ultimately, it is an important part of such an interaction for the individuals that are meeting together to retain contact information and other relevant data about one another. While there have been so many advancements made with respect to the development of portable smart communication electronic devices that utilize the Internet for lighting speed communication, one of the most common ways that people share their contact information is by exchanging printed business cards. Business cards continue to be used for providing contact information and other relevant data about an individual. Notably, it has been statistically reported that over 27 million business cards are printed daily. Thus, business cards are frequently and regularly provided between people for the purpose of exchanging contact information.

However, there are multiple problems associated with this method for sharing a user's contact information. Business cards are often left in a drawer, lost, discarded or forgotten once they are handed out. Another problem is that the contact information on a business card may become outdated and the business card owner must then correct the data and reprint an entirely new batch of business cards. Further, it is a common occurrence that one runs out of business cards, and then has to proceed with sharing contact information in writing. Further, it is possible that one person in a group or couple that is meeting for the first time may have a business card, but the other people do not. Further, whenever a business card is effectively handed out and exchanged between individuals, the recipient of the business card has to take additional steps to benefit from the business card. The recipient of the business card may either store the business card in a designated location with easy access (e.g. rolodex, file, agenda, wallet, etc.). Alternatively, sometime after receiving the business card, the recipient of the business cards transcribes the details of one's contact information and data from the business card elsewhere, such as to a contacts list that is stored on his or her smartphone. It is very easy for errors and mistakes to occur in the transfer process of the data from the printed business card as the recipient may make spelling errors in a person's name, email address, phone number, or other identifying data, which cancels out any benefit from the transfer. Later on, when an individual needs to contact the business card holder whose information he or she has incorrectly saved, the individual may be unable to depending on the nature of the mistake (e.g. a spelling mistake in an email address or incorrect number in a stored telephone number) until the data is correctly obtained. It is also well-known that the process of sharing and handing out one's business cards is considered to be somewhat awkward, and full of potential inconveniences. Additionally, if only one person happens to have business cards on hand and the other individual being met does not, other means must be used to collect the contact information for the individual without business cards.

While it is possible to text and share contact information of a particular individual who is saved in one's smartphone, tablet, or other device, the accuracy of that contact information stored in the electronic communications device is still questionable, because there may have been many errors and inaccuracies when the information was originally entered and stored. Another downside of most methods of transferring user specific data is that the data includes only one or two identifying contact means, such as an email address or telephone number, but may not include a user's social media accounts that the user would like to share for others to access him or her. Thus, it is common to share one's phone number or email address, but to locate each and every social media platform associated with an individual (e.g. Facebook, Instagram, Twitter, LinkedIn, etc.) an individual must separately seek out each of these accounts and verify that they are indeed associated with the particular individual.

Thus, there still exists a need for an improved method of transferring and exchanging contact information between users that provides a more complete and accurate profile of an individual, in a manner that is readily storable and accessible.

### SUMMARY OF THE INVENTION

In view of the foregoing disadvantages inherent in the conventional, known and outdated methods for exchanging contact information, one or more embodiments of a system and method for the exchange of contact information between portable electronic devices (e.g. mobile feature phones, smartphones, personal computers including laptop computers, tablets, digital notebooks, digital watches, etc.) using ultrasonic means is provided herein. The one or more systems and methods provided herein are directed to transfer of contact information, including a user's personal and/or professional contact information, as well as a list of approved social media accounts for the participating user. Beneficially, the user information (i.e. data) that is shared between the portable electronic devices may be exchanged ultrasonically, e.g. using sound waves conducted by air or other medium between the portable electronic devices. A user's contact information may include, but is not limited to, the user's personal or professional telephone number, email address, physical address, or social media account user identification name. It is an object of the present description to provide a much faster, more efficient, more accurate means of exchanging contact information between portable digital devices.

Nowadays, the vast majority of digital devices include microphones and speakers that are built-in from initial construction of and integrated into the digital devices. For the rare cases where a digital device may not have a built-in microphone and speaker, those of ordinary skill in the art understand that the digital device may be adapted (e.g. retrofitted) to include a microphone and speaker. Alternatively, the digital device with the missing microphone and speaker may be connected using wired or wireless means to an auxiliary microphone and speaker.

Beneficially, using one or more embodiments of a system and method provided in the present description, the contact information exchange may occur regardless of the type of portable digital device and irrespective of which operating system the portable digital device uses. In this sense, one or more implementations of a system and method provided in the present description is “platform agnostic” and is configured to work for a wide variety of portable digital devices. This is true because, as long as two portable digital devices that are being used by two owners or operators who want to exchange their contact information include or are otherwise connected to at least one microphone and one speaker, it is possible for the two portable digital devices to exchange their contact information using technology that manipulates acoustic waves to effect the data exchange as further described below.

Furthermore, another important advantage of one embodiments of a system and method described in the present description is the ability for a user to exchange his or her contact information even if the user is “offline”. That is a user may exchange his or her contact information without using wireless communications standards, including those that operate over a network, such as cellular networks (e.g. GSM, CDMA, GPRS, 3G), 802.11 (WLAN), or short range (e.g. BLUETOOTH, Infrared, or RFID) to retrieve and or transmit the data between the involved digital devices. Such a feature is very desirable as it is often the case that users experience poor reception and connection when using a wireless or wired network connection. Nevertheless, in an alternative embodiment, the present description also includes a system and method for the online exchange of contact information between portable digital devices, which may offer additional benefits described further below.

Accordingly, with virtually “a tap” of a button, icon, or any other symbol (including virtual and physical implementations thereof), users of the one or more embodiments provided in the present description may almost impulsively transfer their contact information between participating electronic devices using ultrasonic technology. This may allow for the efficient and accurate exchange of their contact information, including social media accounts and profiles that is a far improvement over the traditional and conventional methods for exchanging contact information as already described above.

An exemplary secure method of transferring profile data comprises utilizing ultrasonic waves having an ultrasonic codec that is transmitted from a transmitting computing device to a receiving computing device. This exemplary method may be utilized by computing devices made by different manufacturers and having different operating systems. An exemplary computing device may be a mobile device such as a cell phone of tablet computer, for example, and the devices may be placed in proximity to each other to initiate the profile data transfer via ultrasonic waves. A transmitting device may transmit the ultrasonic waves through a speaker on the mobile device or through an auxilllary speaker. The receiving device may receive the ultrasonic codec through a microphone, such as on the mobile device or an auxiliary microphone.

Profile data may include a user's phone number, address, email address, as well as social media information including user names for social media websites, for example. A user may have a personal profile that includes personal information including social media information and a separate profession profile that includes work contact information, position, title, place of employment and the like.

Each of the computing device may comprise information exchanger software that enables the transfer of profile data through ultrasonic waves. A user may interace with the information exchanger software to transmit and/or receive profile information. Again, mobile devices with different operating systems may effectively transfer profile information using ultrasonic waves.

An audible sound, or sound token, may be emitted when a computing device has verified receipt of untrasonic wave profiled information and/or when a connection is confirmed with a sending or receiving computing device. A sound token may have a frequency that is audible such as betweenabout 16 kHz to 20 kHz, or between 18.1 kHz and 20.5 kHz. An initialization process may be implemented between computing devices to confirm that they are within range and that profile data is ready for transmission.

Ultrasonic waves are a type of sound waves having a frequency of about 16 kHz to 1 GHz and may be above an audible sound frequency, such as above 20 kHz. Audible sound is generally between 20 Hz and 20 kHz. The profile data may be transmitted with an initiation portion and termination portion, whereby the receiving device know that the pertinent profile data is after the initiation portion of the sound wave transmitted, and/or before the termination portion of the sound waves transmitted.

The foregoing summary is illustrative only and not intended to be in any way limiting. Other aspects and advantages of the invention will be apparent from the following description and the appended claims.

### BRIEF DESCRIPTION OF SEVERAL VIEWS OF THE DRAWINGS

The present invention will be described by way of exemplary embodiments, but not limitations, illustrated in the accompanying drawings in which like references denote similar elements, and in which:

FIG. 1 is a block diagram of non-limiting computing devices included in an exemplary system for exchanging a user's contact information in accordance with an illustrative embodiment.

FIG. 2 is a pictorial illustration of an exemplary screenshot of a user profile pane from a contact exchange application in accordance with an illustrative embodiment.

FIG. 3 is a pictorial illustration of exemplary screenshot of another user contact pane for a contact exchange application in accordance with an illustrative embodiment.

FIG. 4 is pictorial illustration of a send and receive panel in accordance with an illustrative embodiment.

FIG. 5 is a flowchart for a method for exchanging contact information via ultrasonic waves in accordance with an illustrative embodiment.

FIG. 6 is a pictorial illustration depicting an embodiment of a system for computing devices that does not include a feature phone in accordance with an illustrative embodiment.

FIG. 7 is a flowchart of an exemplary process for implementing a proximity verification process using the components of FIG. 6 in accordance with an illustrative embodiment.

FIG. 8 is a pictorial illustration depicting an embodiment of a system for computing devices that includes a feature phone in accordance with an illustrative embodiment.

FIG. 9 is a flowchart of an exemplary process for implementing a proximity verification process using the components of FIG. 8 in accordance with an illustrative embodiment.

FIG. 10 is a pictorial illustration of components of a system for offline data exchange via ultrasonic means in accordance with an illustrative embodiment.

FIG. 11 is a flowchart for the system shown in FIG. 10 in accordance with an illustrative embodiment.

FIG. 12 is a pictorial illustration depicting an embodiment of a network environment in accordance with an illustrative embodiment in accordance with one embodiment.

FIG. 13 is a pictorial illustration of a data processing system in which embodiments may be implemented.

### DEFINITIONS

For clarification of terms describing features of one or more embodiments of a method according to the present invention, as claimed herein, particular terms are defined below:

“Computing Device” may include, but is not limited to, any type of mobile telephone including smartphones or feature phones, tablets, laptops, notepads, personal digital assistants (PDAs), smartwatches (or other similar wearable technology including GOOGLE glasses). Computing devices may also refer to non-mobile computing devices, including, but not limited to, desktop computers.

“Smartphone” may be a mobile communications device that runs an operating system that supports third-party applications, includes a touchscreen, multimedia and internet capabilities, as well as voice calling, text messaging, and other functions offered by the user's wireless service provided.

“Feature phone” may be a mobile communications device that shares some of the functions and aspects of a smartphone, but may be more limited in its ability to operate across multiple operating systems, to operate third party applications, and may not necessarily include a touch screen.

“Audio hardware” may refer to a microphone and speaker in a portable digital device.

“Broadcast” may refer to the action of audio playback.

“Capture” or “Scan” may refer to the action of audio recording.

“Client” may refer to an entity willing to become a member of a session by fulfing a proximity verification process.

“Entity” may refer to any actor interacting with the system and may have “the host” or “Party” role.

“Host” the entity that opens a session. It may be the entity that initially owns the session password and can manage it.

“Party” may refer to a client that is connected to profile data session with a SessionID.

“Property” may refer to Key-value pairs used by the session entities to exchange information.

“Proximity verification” may refer to a process that ensures, after a successful audio broadcasting/capture processes by the involved entities, that the involved entities are located sufficiently proximate to one another.

“Session” refers to a profile data transfer event between parties.

“Session password” may refer to the password that is assigned to the host and used to manage the corresponding session.

“Session ID” is a unique alphanumeric value that gives access to a session facilities and properties.

“Sound data” is the audio information exchanged by the entities during a profile data transfer event.

“Codec” is a device or program that compresses data to enable faster transmission and decompresses received data.

### DETAILED DESCRIPTION OF THE ILLUSTRATED EMBODIMENTS

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Further, the term “set” as used herein may mean one or more items. Additionally, reference to the singular is also to be construed to relate to the plural, such the terms “a” and “an” or “the” may also be construed to refer to a plural amount of the item that they refer to, unless the context clearly prohibits doing so.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The present disclosure is generally drawn to one or more systems and methods for exchanging user contact information using ultrasonic waves to transmit the user contact information. Numerous drawbacks and challenges exist with current methods and technologies for exchanging data. Contact exchange practices are outdated, slow, inefficient, and imperfectly digitized. When business cards are exchanged, they are often forgotten, lost, end up in a drawer, piled up on a desk, or are discarded before the contact information is uploaded to another location.

From a technology standpoint, NFC (Near Field Communications) is not a smartphone industry wide standard and is not supported with lower end or older devices (feature phones, flip phones, etc.). BLUETOOTH pairing incompatibilities still exist across many platforms (iOS, ANDROID, WINDOWS), is insecure, drains battery power, and requires pairing with another device prior to data exchange which is a slow, cumbersome, and an inefficient contact exchange experience. Further, synchronizing new contact information with customer relationship management (CRM) systems is both daunting and time consuming. Accordingly, there still exists a need for an improved method and system of exchanging user contact information that capitalizes on the prevalence of computing devices in today's modern world.

In particular, the different illustrative embodiments take into account that it may be desirable to provide for a mobile application enabling personal contact information and social media account sharing through ultrasonic audio technology. Accordingly, according to one or more embodiments, a computer-implemented mobile application is described herein that may be downloaded or installed on a computing device for the purpose of enabling a user to store one or more profiles that includes the user's personal or professional contact information. Further, the computing application, according to embodiments in the present description, includes the capability of customizing the user profile so that the user may selectively share tailored profiles that may include different contact information for each created profile associated with the computing application. It is an object of the present description that a user is able to share his or her contact information from a variety of computing devices, including smartphones, feature phones, laptops, personal computers, tablets, PDAs, wearable smart watches, and other digital devices.

In one or more embodiments, an ultrasonic codec in the form of a program is included with embodiments of the user contact information computing application. The ultrasonic code, in one or more embodiments, is configured to broadcast and receive audio tokens between two involved computing devices to determine whether the computing devices are located within sufficient range of each other. The audio tokens may be transmitted between one device to another via speakers and microphones that are located in or coupled to the computing devices. The one or more embodiments for a system and method provided in the present description provide a variety of benefits and advantages over conventional and existing methods and technologies of exchanging contact information. Further details regarding the one or more embodiments for operating such a system and implementation of a process for exchanging user contact information are provided below.

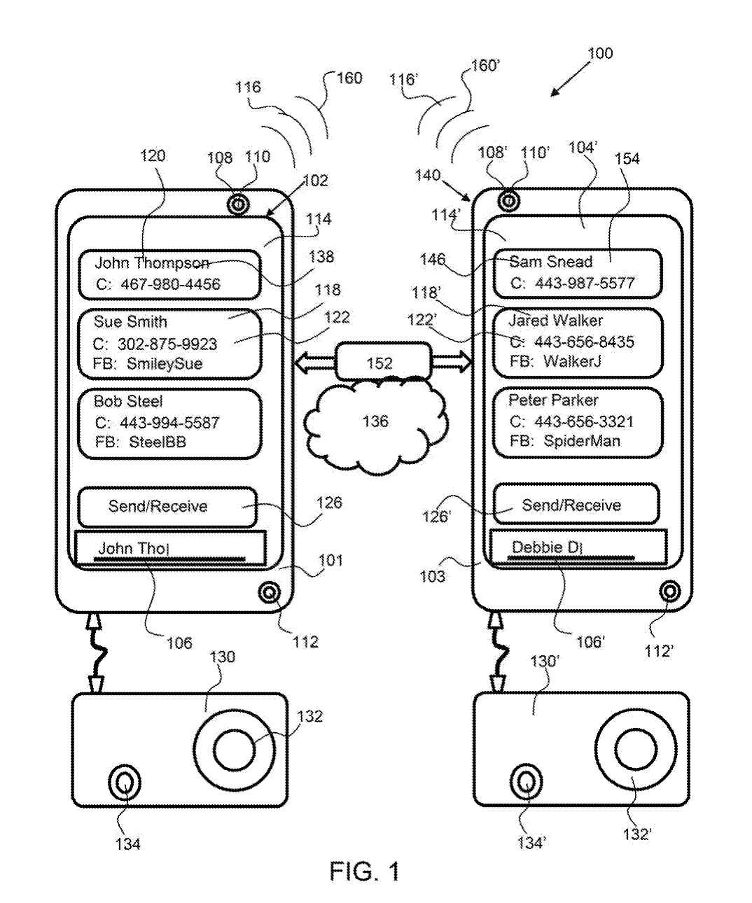

Turning to FIG. 1, FIG. 1 is a block diagram illustrating an exemplary system for exchanging user contact information between computing devices 102, 140 using ultrasonic waves 160, 160′. System 100 illustrated in FIG. 1 allows for the transfer and communication of data, in particular contact information for User 101 and User 103, using sound waves to securely and quickly transfer the relevant contact information of each user. Profile data, may include “Contact information” as used in the present description may include, but is not limited to, any telephone numbers, email addresses, physical addresses, web addresses, i.e. uniform resource locators (“URLs”), social media account links, usernames, fax numbers, or any other type of contact information known in the art that may be associated with a person and/or business entity. Further, the contact information may include personal or professional, work-related, contact information. Thus, the contact information may be customized to include a combination of personal contact information and work-related contact information, or may simply be a collection of either personal or work-related contact information depending on which profile an individual chooses to share with another individual. For example, a user may desire to create a profile that is customized to include their personal contact information such as his or her personal telephone numbers including home or mobile telephone number, social media account links, email addresses, etc. Additionally, or alternatively, a user may desire to create a profile that is customized to include his or her professional contact information, such as his or her professional telephone numbers, business email addresses, business web sites, business social medial links, etc.

FIG. 1 further illustrates a non-limiting embodiment of a contact information exchange application, such as contact information exchanger 114, a software program located, at least in part, on computing device 102 and also located, downloaded or otherwise installed via computer readable storage medium, on computing device 140, in accordance with one or more embodiments of the present claimed invention. Contact information exchanger 114 enables a user to more securely, quickly, and accurately create and share their customized personal and/or professional contact information, such as telephone numbers, email addresses, physical addresses, social media account links or user names, etc. Accordingly, contact information exchanger 114 is a software application that is executable on computing devices 102 and 140 that allow a user to create profiles that may be shared and edited on a regular basis with other individuals. A user, such as user 101 and user 103, accesses contact information exchanger 114 via their respective computing devices 102 and 140.

In other words, contact information exchanger 114 shown in FIG. 1 is a software module containing various sub-modules such as a user profile pane 118 and address book pane 122 that allow a user to enter and organize relevant their relevant contact information in unique profiles such as a set of profiles 120 on computing device 102 and set of profiles 154 on computing device 140. As used herein, a “module” may be any type of software application configured to operate on computing devices 102 and/or 140, which includes mobile or non-mobile computing devices.

As shown in FIG. 1, user 101 is a person with privileges and rights associated with contact information exchange 114 on computing device 102. Likewise, user 103 is a person with privileges and rights associated with contact information exchange 114 on computing device 140. It is noted that user 101 or user 103 (or any “user”) may be, but is not limited to also being an owner of a computing device. Thus, there may be occasions whereby the user is utilizing a computing device that he or she does not directly own, but the user still has rights and privileges associated with this device. For example, in a work setting, a user may be assigned to and have rights and privileges for any number of computing devices, such as work authorized telephones and/or tablets. Accordingly, it is foreseeable that a user may still use one or more computing devices to implement one or more steps of processes described herein and in conjunction with one or more components of system 100 even though the user does not necessarily own this computing device.

Computing devices 102 and 140 may be implemented as any type of computing devices, such as, but not limited to, a smart phone, a feature phone, a laptop computer, a tablet computer, a personal digital assistant (PDA), a smart phone, a smart watch, or a wearable computer with optical head mounted display, such as, but without limitation, Google Glass®, as well as any other type of computing device including a desktop computer. Thus, computing devices 102 and 140 may be a mobile or non-mobile computing devices. The term “mobile” refers to a computing device that is quickly and easily transportable. An exemplary mobile device is easily carried by a user by hand and may have no dimension greater than 50 cm and may have wireless connection and communication features. A mobile computing device includes, without limitation, mobile phones, also referred to as cellular phones or smart phones, laptops, and tablet computers. A non-mobile computing device is a computing device, such as, but without limitation, desktop computers that are not regularly transported or typically carried around by the associated users.

Advantageously, system 100 includes the feature that computing device 102 and computing device 140 may be different types, makes, or models of computing devices and may include different operating systems. Accordingly, the contact information shared between computing devices 102 and 140 via contact information exchanger 114 may be shared regardless of the type of computing device or operating system. For example, system 100 is functional for sharing contact information between user 101 and user 103 even if computing device 102 that is associated with user 101 is a smart phone while computing device 140 associated with user 103 is a tablet made by a different company and operating on a different operating system. Accordingly, computing devices 102 and 140 do not have to be the same type or model or version of computing devices in order to operate correctly in accordance with one or more steps of a method described herein.

For purposes of simplification, one or more components that are known in the art to be included with computing devices like 102 and 140 are described below, but with the understanding that computing devices 102 and 140 are separate devices that belong to different users, i.e. users 101 and 103. Computing devices 102 and 140 include many components known to one of ordinary skill in the art, including, but not limited, to a user interface 106, 106′ for user 101 or 103 to enter in relevant data into contact information exchanger 114 from 102 and computing device 140, respectively. As shown in FIG. 1, computing devices 102 and 104 include user interface 106, 106′, respectively. A user interface, in general, as utilized herein, may mean any type of user interface known to those skilled in the art including keyboards, a touchscreen, verbal input, and a computer mouse. In one or more embodiments, a user interface may comprise, without limitation thereto, a keyboard. The keyboard may be connected to computing devices 102 and 140 through a cable or wire. The keyboard may also be connected via Bluetooth or a Wi-Fi Internet connection. Additionally, or alternatively, such a keyboard may be a touch screen simulated keyboard that is included with various smart phones, tablets, and computers. By utilizing user interface 106 associated with computing device 102, users 101 and 103 are respectively able to enter data into contact information exchanger 114.

Computing devices 102 and 140 further includes display device 104. Display device 104 may be any type of display devices known in the art, including, without limitation, a screen capable of generating an image. Accordingly, display device 104 may be implemented as a computer monitor, a touch screen, a liquid crystal display (LCD) screen, a plasma screen, mobile phone display screen, an optical head mounted display, or any other type of device known in the art.

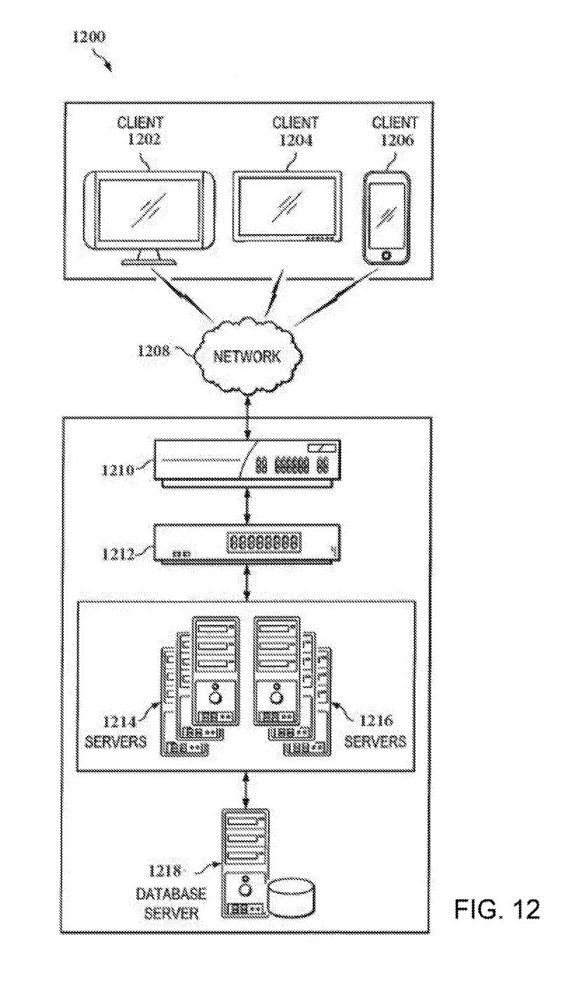

In this illustrative embodiment, computing devices 102 and 140 are capable of connecting to a remote database such as a cloud system 136 via the Internet. Cloud system 136 provides cloud service and cloud computing system. Cloud system 136 is a service that allows users, such as users 101 and 103, to sync and backup any information associated with contact information exchanger 114 to one or more remote computer servers, such as, but without limitation, servers 1214-1218 in FIG. 12 below.

User 101 or 103 is able to backup data stored on computing devices 102 and 140, respectively, to cloud system 136. Cloud system 136 also acts as a data syncing center for any data associated with the sub-modules associated with contact information exchanger 114. In one embodiment, cloud system 136 is configured to allow user 101 or 103 to wirelessly back up to a cloud storage system associated with cloud system 136 from any computing device associated with user 101 or 103.

Furthermore, cloud system 136 is configured to allow user 101 or 103 to download data associated with contact information exchanger 114 to multiple devices associated with user 101 or 103, including mobile phones, laptop computers, desktop computers, and/or computer tablets associated with user 101 or 103. Ultimately, a user associated with a contact information exchanger (e.g. 114) is able to access this software application from multiple computing devices and access the same set of data from multiple computing devices as long contact information exchanger 114 has been installed on these devices.

In order to implement the exchange of the contact information, it may be necessary for a computing device associated with a user to include or to be coupled to a microphone and a speaker. Computing devices 102 and 140 shown in FIG. 1 may each include their own built-in, integrated, audio hardware 108, which further includes speaker 110 and microphone 112. Any suitable speaker and microphone as known by those skilled in the art may be included with each of these computing devices. In the rare case where either or both computing devices 102 and 140 do not include built-in audio hardware, a user may retrofit their computing devices to include such audio hardware.

Alternatively, a user may couple auxiliary audio hardware, such as auxiliary audio hardware 130 using either wired or wireless means known in the art. Auxiliary audio hardware 130 may include auxiliary speaker 132 and auxiliary microphone 134. The auxiliary speaker 132 and auxiliary microphone 134 may be used to transmit the audio tokens and data in sound waves from computing device 102 to computing device 140.

Contact information exchanger 114 is a software application that includes sub-modules designed to facilitate the creation and exchange of user contact information. Contact information exchanger 114 is able to be send or receive data embedded in ultrasonic waves that are communicated to a nearby computing device that is within range. An exemplary range may be about 35 cm or less, or 25 cm or less or even 12 cm or less and may depend on the noise level conditions.

Each application for contact information exchanger 114 includes an ultrasonic codec, such as ultrasonic codec 116 that is embedded or integrated into the operation of contact information exchanger 114 and the computing device (e.g. 102 or 140) on which contact information exchanger 114 is installed. A “codec” as used herein refers to a program used to compress data to enable faster transmission and decompresses received data. Accordingly, ultrasonic codec 116 as shown in FIG. 1 on computing devices 102 and 140 is a codec that is enabled to transmit compressed data and to decompress received data ultrasonically (via sound waves).

Ultrasonic waves are not usually audible to the human ear unless at a very low level of the ultrasonic frequencies. Acoustic frequencies between 16 kHz and 1 GHz are usually referred to as ultrasound or “ultrasonics.” Audible sound that a human ear can hear tends to include frequencies that range between 16 Hz and 20 kHz. Accordingly, there is a slight overlap between audible sound and ultrasound however, the larger majority of frequencies included in ultrasonics are inaudible to the human ear.

According to one or more embodiments, there may be multiple advantages and features provided with ultrasonic codec 116. Namely, ultrasonic codec 116 enables a user to transmit their contact information regardless of the type of computing device or operating system used on the computing device. Accordingly, ultrasonic codec 116 may be provided for any type of operating system on any type of computing device, including, but not limited to, Android, iOS, Java, Javascript, Windows, ASP.NET MVC, etc.

An additional benefit provided by ultrasonic codec 116 is that, in one or more embodiments, ultrasonic codec 116 is configured to allow for “Full-Duplex” transmission of data packages. “Full-Duplex” as referred to herein refers to the ability to transmit and receive data communications in both directions at the same time. Accordingly, in one or more embodiments, ultrasonic codec 116 defines a bandwidth as a useful channel for transmission of data and is able to send and receive transmission over the full useful bandwidth without self-interference. This is advantageous as other codecs must divide the frequencies up in two in order to achieve Full-Duplex. Thus, in a non-limiting example, ultrasonic codec 116 shown in FIG. 1 may be configured to transmit and receive simultaneously over one bandwidth that comprises, for example purposes only, but without limitation thereto, between 18 khz and 21 khz. Other codecs typically have to allot one bandwidth for sending (e.g. 18 kHz to 19 kHz) and one bandwidth for receiving (e.g. 19.5 kHz to 21 kHz).

In a preferred, non-limiting embodiment, ultrasonic codec 116 is a codec developed and integrated as software using a software development kit (SDK) provided by COPSONIC. COPSONIC is a patented technology that enables the ultrasonic embedding of data and transmission thereof between computing devices. It has been utilized for transmitting payment data, remote control of home appliances, and various other uses. However, there has not been any application or enablement prior to the one or more embodiments claimed in the present description for utilizing the COPSONIC ultrasonic codec to transmit and receive user contact information. A patent is pending before the European Patent Office (EPO) for COPSONIC, which is French Patent No. FR 16.55443 and is incorporated herein in its entirety. Those of ordinary skill in the art will appreciate that other codecs, other than that developed by COPSONIC may also be utilized in one or more implementations of system 100 shown in FIG. 1 and methods for using the same.

Nevertheless, COPSONIC provides a robust native codec specialized for data transmission over the air. It is notable that no new codecs or technologies like COPSONIC adapted to the domain of acoustic waves have been proposed since DTMF, PSK, FSK, OFDM (which are examples of prior codecs existing in the field), created 13 years ago or more. It is also a feature of COPSONIC's developed codec as adapted for system 100 in the present description that the data transmission of a user contact information may be more secure. Ultrasonic codec 116 may be much harder for a malicious actor who seeks to identify or intercept any data that is being transmitted ultrasonically, in particular, when utilizing COPSONIC's developed codec. This is because, with every codec, transmitted information is divided into a set of basic information units called symbols. The way to recover these symbols should only be known to friendly receivers. With COPSONIC's codec, regardless of the information sent between two devices, the frequency content will be very similar also the symbols time-waveform transitions will be masked which makes it slow and computationally complex for a malicious actor to recover the broadcasted symbols and in general the sent information. Accordingly, the codec utilized in ultrasonic codec 116 in system 100 is more secure as compared to other codecs.

Further, additional benefits exist in utilizing COPSONIC's codec to underscore ultrasonic codec 116. For example, COPSONIC's codec is designed for improving the amount of information or symbol diversity that can be sent over a given frequency band before reaching the upper bound when compared to other codecs. For a given frequency band, there is always a boundary in how much information can be sent and recovered successfully. Depending on the used codec, there is a tradeoff between used frequencies and the reliability of the information that can be recovered, where in general as more frequencies are used there is a bitrate improvement or symbol diversity increase until the frequency band becomes saturated which imposes an upper bound to the speed or maximum number of simultaneous communications in this frequency band. Ultimately, ultrasonic codec 116 in utilizing COPSONIC's codec, in one or more non-limiting embodiments, may be more powerful and make better use of available ultrasound bandwidth. The amount of power offered by the use of COPSONIC's codec does not compromise the speed provided by COPSONIC's codec either. In a few experimental implementations thereof, COPSONIC's codec enabled an increase in bitrate (the number of bits per second that may be transmitted over a digital network) of twice that of other codecs under similar testing conditions. In some test cases, ultrasonic codec 116 is able to reach over 3.6 kbps using a frequency band of 18.1 kHz to 20.5 kHZ.

Accordingly, multiple advantages are present when utilizing contact information exchanger 114 and integrated submodule ultrasonic codec 116, including faster bitrate, the ability for full-duplex data transmission, and a more secure means of transfer of sensitive user profile data that is harder to reverse-engineer.

In one or more embodiments, ultrasonic codec 116 is an integrated sub-module with contact information exchanger 114. Further, contact information exchanger 114 communicates with a backend authorization service, such as backend authorization services 152. In one or more embodiments, backend authorization services 152 may be stored on one or more servers. A server utilized to implement backend service 152 may be any suitable type of server known in the art. Further, backend authorization services 152 may be stored on one or more servers, such as servers 1214-1218 shown in FIG. 12 and described further below.

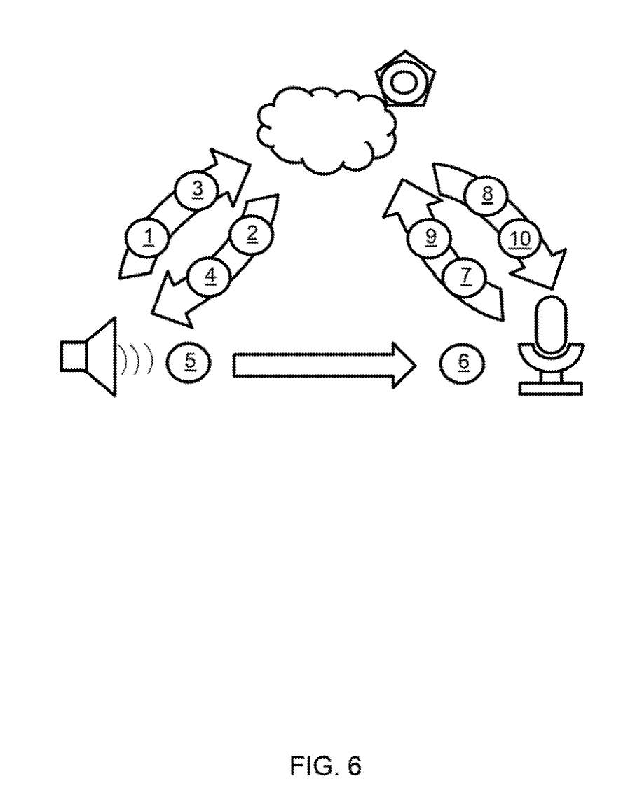

Backend authorization service 152 may provide a number of authentication and identification services needed in the transfer of data between computing devices 102 and 140 ultrasonically. In particular, backend authorization service 152 may provide audio tokens that are used during a proximity verification carried out by a requesting entity (i.e. computing device) to initiate the data transfer process using ultrasonic means. More description of backend authorization service 152 is provided in association with FIGS. 6-13.

In addition to the above, contact information exchanger 114 may include a number of sub-modules, such as user profile pane 118, address book pane 122, and send and receive pane 126, without limitation thereto. User profile pane 118, address book pane 122, and send and receive pane 126 may each have a homepage for their respective pane. In one example, user profile pane 118 may be used to create one or more user profiles containing the set of contact information and/or social medial accounts (if included) as desired by a user. User 101 of computing device 102 may thus create a set of unique profiles, such as set of profiles 120. As described above, “set” as used herein may refer to one or more. Thus, it is possible that user 101 has only one user profile in association with user profile pane 118 and stored with contact information exchanger 114. On the other hand, user 101 may have several user profiles associated with set of profiles 120 and in conjunction with contact information exchanger 114.

Likewise, user 103 who is a separate entity from user 101 and whose computing device 140 is physically decoupled from computing device 102, may also create his or her own set of profiles 154 to be saved with contact information exchanger 114 that is stored on computing device 140. It is an object of the present description that each user may select whether to include only personal or professional or a combination of contact information in a particular user profile. Further, it is an object of the present description that a user may select whether to include some or all of the social media account usernames/handles/profiles associated with the user.

Accordingly, each profile that a user creates as part of his or her set of profiles 120 or 154 may include a set of fields that a user may fill out with desired information. For example, a user profile may include a number of fields that appear in a home page associated with user profile pane 118 to assist a user in entering common categories of contact information. A user may be prompted to enter in a description or category associated with his or her professional title, such that the user may be enabled to enter their occupation (e.g. engineer, manager, attorney, teacher, etc.) and the name of the company or business entity with which they are associated. Notably, there are multiple fields where a user may enter his or her telephone numbers, email addresses, physical address, as well as a set of fields to associate his or her social media account addresses.

As used herein, “social media account” may refer to any type of social media application known in the art, including, without limitation thereto, FACEBOOK, LINKED IN, TWITTER, INSTAGRAM, SNAPCHAT, VENMO, PINTEREST, BUSINESS CARD, and KIK. Social media applications may be accessible via their own URL addresses on the web or may also include separately downloadable applications that may be stored and operated on a user's computing device. Social media applications have become increasingly important for many people and how they choose to express their identity. A social media account, especially the user accounts found on FACEBOOK, TWITTER, INSTAGRAM or LINKED IN are known for facilitating and allowing people to share a great deal of information about themselves. In particular, a person using any one of the social media applications mentioned above can share with their friends and contacts a great deal about their personality, interests, hobbies, skills, and work life. Further, a user may have a profile created using a social media application that they primarily use for either personal or professional reasons. Therefore, it is an object of the present invention that a user may easily link all of his or her social media accounts, whether used primarily for personal or professional purposes, with one or more of their profiles on contact information exchanger 114. Further, the user is enabled to quickly and securely transmit their profiles via sound waves transmitted from their audio hardware (e.g. audio hardware 108 or 130) on one computing device (e.g. 102) to a nearby computing device 140.

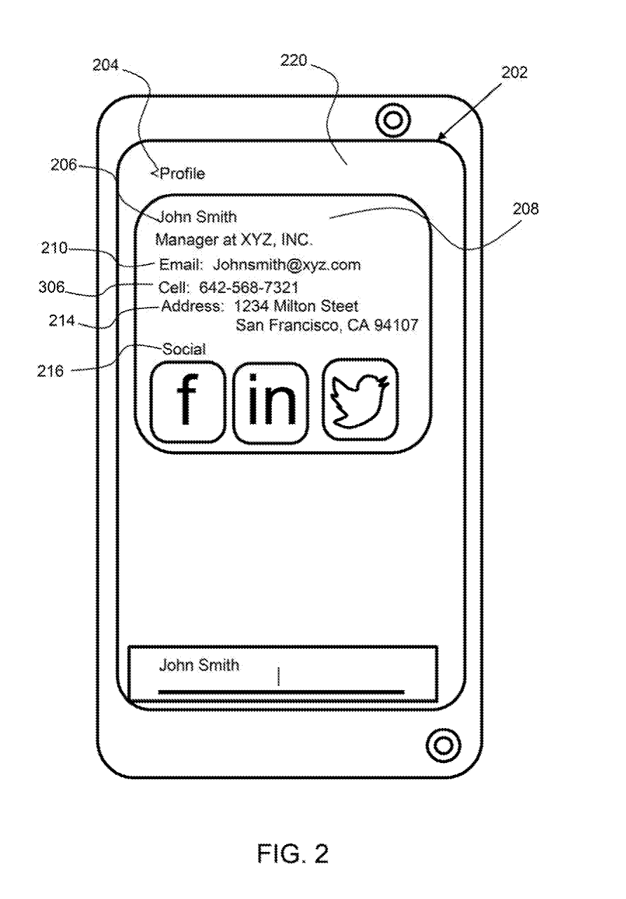

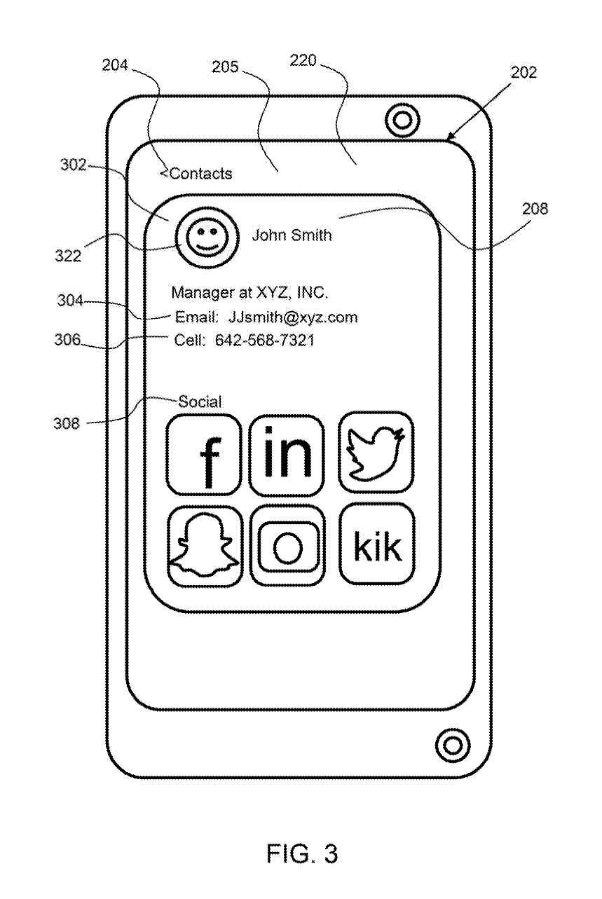

FIG. 2 is an electronic device with a user profile page display 206 and FIG. 3 is an electronic device with a user contact page display. 114. FIG. 2 provides and exemplary non-limiting pictorial illustrations of a user profile that may be used in conjunction with a contact information exchanger, such as contact information exchanger 114

FIGS. 2 and 3 include computing device 202, which may be a computing device in accordance with computing devices 102 and 140 as described above and shown in FIG. 1. In FIG. 2, “John Smith” has created a professional user profile, while as shown in FIG. 3, “John Smith” has created a personal user profile that does not include his professional or work-related contact information. Thus, “John Smith” has the freedom to select what profile to share and which type of contact information to include in that profile.

In the non-limiting example shown in FIG. 2, contact information exchanger 208 is a software application stored on computing device 202. Contact information exchanger 208 may be an application in accordance with contact information exchanger 114 shown in FIG. 1 and described above. Further, computing device 202 may be a computing device in accordance with computing devices 102 and 140 in FIG. 1. As shown in the example in FIG. 2, computing device 202 is a smartphone 220, although other types and models of computing devices may be used instead. As shown in FIG. 2 and FIG. 3, smartphone 220 has a touchscreen 205 that a user utilizes to interface with one or more applications or other components of smartphone. Additionally, smartphone 220 includes a visible home button that may be used to access a central homepage of the smartphone, a speaker, camera, microphone, and many other standard components that one of ordinary skill in the art would expect smartphone 220 to include. Those of ordinary skill in the art will understand that smartphone may have other configurations and components not visible in FIG. 2 or 3.

Contact information exchanger 208 includes user profile 206 and user profile 302 (shown in FIG. 3) for the same user, i.e. “John Smith”. The user may thus create a professional user profile, which is displayed in FIG. 2 as user profile 206 and may create a personal user profile, which is displayed in FIG. 3 as user profile 302. Thus, user profile 206 includes several fields that a user may choose to include. For example, John Smith's work title and business entity (e.g. “Manager at XYZ, Inc.”) is included in his user profile 206. Further, his work email 210, work phone number 212, and work address 214 may all be included in his professional work profile 206. In addition, John Smith in FIG. 2 has included his links to some social media applications 216 such as his FACEBOOK, LINKED IN, and TWITTER accounts as displayed on display screen 204.

FIG. 3 shows user profile 302, which may be a user profile also associated with contact information exchanger 208. User contact 302 may be more oriented to John Smith's personal contact information, such that user description 322 may be more lighthearted or descriptive of his personal hobbies, and user profile 302 may also include his personal email address 304, personal telephone number 306, and all (or some) of his social media accounts 308 as shown in the non-limiting image in FIG. 3.

Referring back to FIG. 1, contact information exchanger 114 may further include address book pane 122 that has a set of contacts 138 located therein. Address book pane 122 may be a sub-module of contact information exchanger 114 that allows a user to edit and organize their own contacts included in address book pane 122. Address book pane 122 may be sorted alphabetically or via any other method known in the art or preferred by user. In one or more embodiments, a user may also save the contact information as stored in address book pane 122 in contact information exchanger 114 to the contacts component or module that is separately stored on the user's computing device. The contact information received through the information exchanger may store the contact information in an existing or standard address book of the computing device. The information exchanger may interface with the computing device to store contact information for quick retrieval through a standard computing device system.

In addition to the above, user 101 has his or her own contacts 138 associated with the address book pane 122 stored on computing device 102. Conversely, user 103 has his or her own contacts 146 associated with the address book pane 122′ stored on computing device 140. Each user will have their own contacts stored and easily accessible from the contacts pane (i.e. contacts 138 or contacts 146) in each individual user's address book pane.

In one embodiment, contact information exchanger 114 further includes a send and receive pane, such as send and receive pane 126. Send and receive pane 126, in accordance with one exemplary non-limiting embodiment, may be a horizontally divided page that allows a user to select to send his or her contact information as well as to select to receive another user's contact information. The contact information will be shared as a user profile (e.g. one of the set of profiles 120 for user 101 or one of the set of profiles 154 for user 103). As noted above, ultrasonic codec 116 as integrated into contact information exchanger 114 allows for Full-Duplex transmission, i.e. sending and receiving almost simultaneously of data.

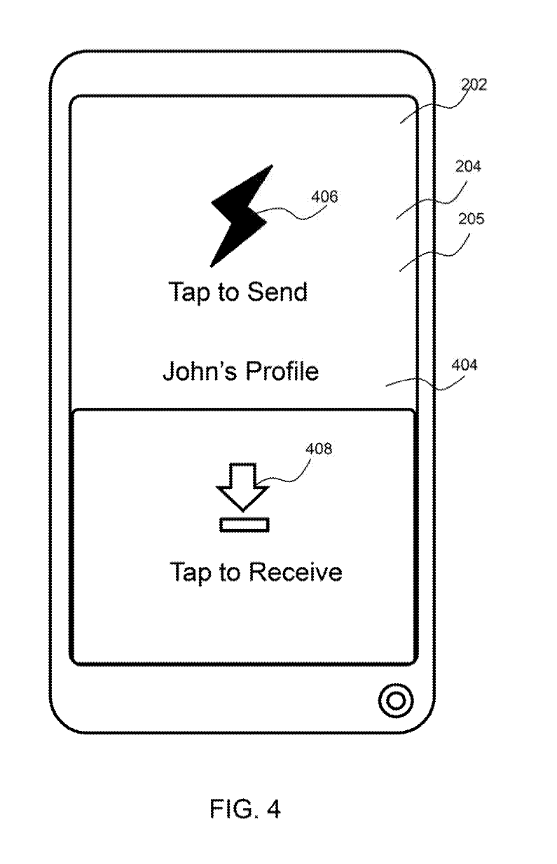

FIG. 4 is an exemplary pictorial illustration of a send and receive pane shown as send and receive pane, such as send and receive pane 126 in FIG. 1. Send and receive pane 404 may be an exemplary send and receive pane in accordance with send and receive pane 126 shown in FIG. 1 and described above. Send and receive pane 404 may be visible on the display screen 204 for computing device 202, which is associated with John Smith's user profiles and contact information exchanger 208 shown in FIGS. 2 and 3. Accordingly, when a user is ready to share his or her user profile, such as user profile 206 in FIG. 2 or 302 in FIG. 3 (or any other profile as desired) the user may select an icon such as icon 406 to send his user profile. Conversely, to receive another user's contact information stored as a profile, the user associated with computing device 202 may also select icon 408. The ultrasonic codec may be sent from the computing device for a transmit period of time and may record sent ultrasonic sound through the microphone for a receiving period of time. The transmit and receiving times may be less than about 30 seconds, less than about 20 second, or less than about 10 seconds, such as from 1 to 10 seconds and any range between and including the times provided. In an exemplary embodiment, once the sender initiates transmission of contact information, there is an 8 second window during which data is actively being transmitted. The receiver has to tap receive on their electronic device within that this time frame to receive the information from the sender. In order to exchange contact information, one device must be in the sending state, while the other must be in the receiving state. It is a one way exchange.

Those of ordinary skill in the art will appreciate that alternatively a user may use any means known in the art to transmit a “send” or “receive” command or instruction, including, but not limited, using voice activated commands or other mechanisms known in the art. Further, it is noted that the illustration of the send and receive pane 404 shown in FIG. 4 is merely exemplary and not meant to be limiting whatsoever. Other embodiments are foreseeable and within the scope of the present description for displaying to a user to send and/or receive user profile data, including, but not limited to, including an icon, image, or other selector in the user profile as stored on user profile pane 118.

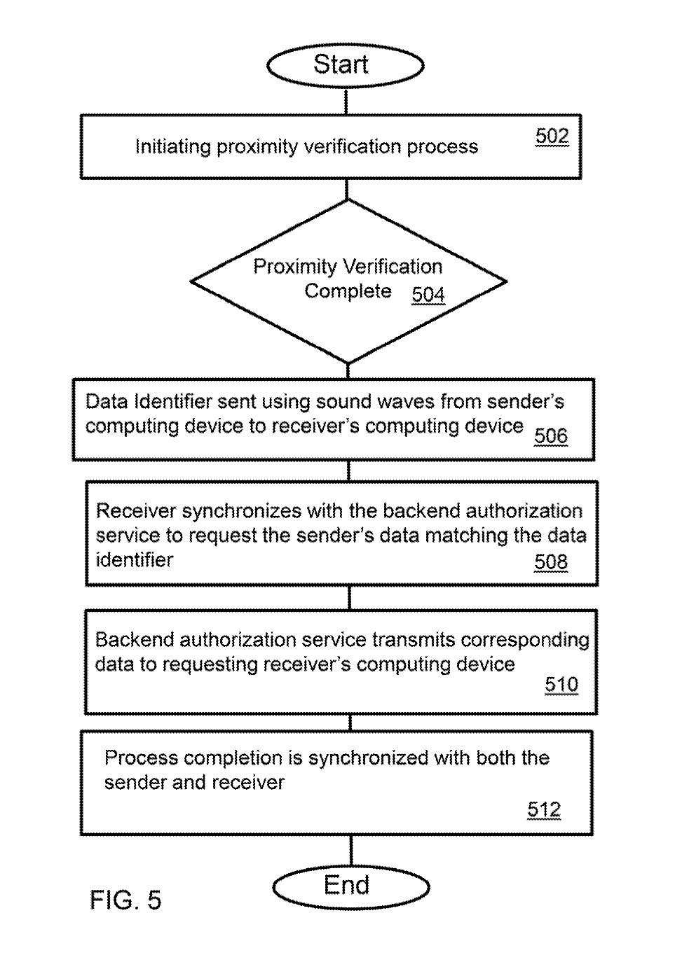

Turning to FIGS. 5-10, each of the Figures provides a non-limiting set of steps in accordance with one or more exemplary, non-limiting embodiments for operating a contact information exchanger, such as contact information exchanger 114 in FIG. 1. Additional components of system 100 shown in FIG. 1 may also be utilized in conjunction with one or more steps included in FIGS. 5-10.

FIG. 5 provides a flowchart of an exemplary process for exchanging contact information between computing devices (e.g. such as computing device 102 and computing device 140). The process starts, in one exemplary embodiment, by initiating a proximity verification process between a sender's computing device and a receiver's computing device (step 502). In an exemplary embodiment, a proximity verification process ensures that the two computing devices are within close enough range to transmit data between each device, as well as to ensure that the computing devices are engaged in the transfer of the correct data. Accordingly, this exemplary process may include an ultrasonic key, i.e. data identifier that is assigned to a user's profile that is being passed between computing devices (step 506). In one embodiment, the sending computing device (e.g. 102) acts as the “host” computing device. Further, the receiver's computing device acts as the “client” computing device. In an alternative embodiment, a proximity verification process is not required. The transmission of data may be proactive, wherein the data being transmitted is received by a receiving device that has the information exchanger program open and/or a user actives reception by tapping a receiving icon or button on the receiving device.

As used herein the sender and the receiver may also be referring to the sender computing device and to the receiver computing device.

Next, the receiver synchronizes with a backend authorization service to request the sender's data matching the data identifier (step 508). In one or more embodiments, a backend authorization service may be in accordance with backend authorization service 152 shown in FIG. 1 and described above. The process may continue with the backend authorization service transmitting corresponding data to the requesting receiver's computing device (step 510). Subsequently, process completion is synchronized with both sender and receiver (step 512).

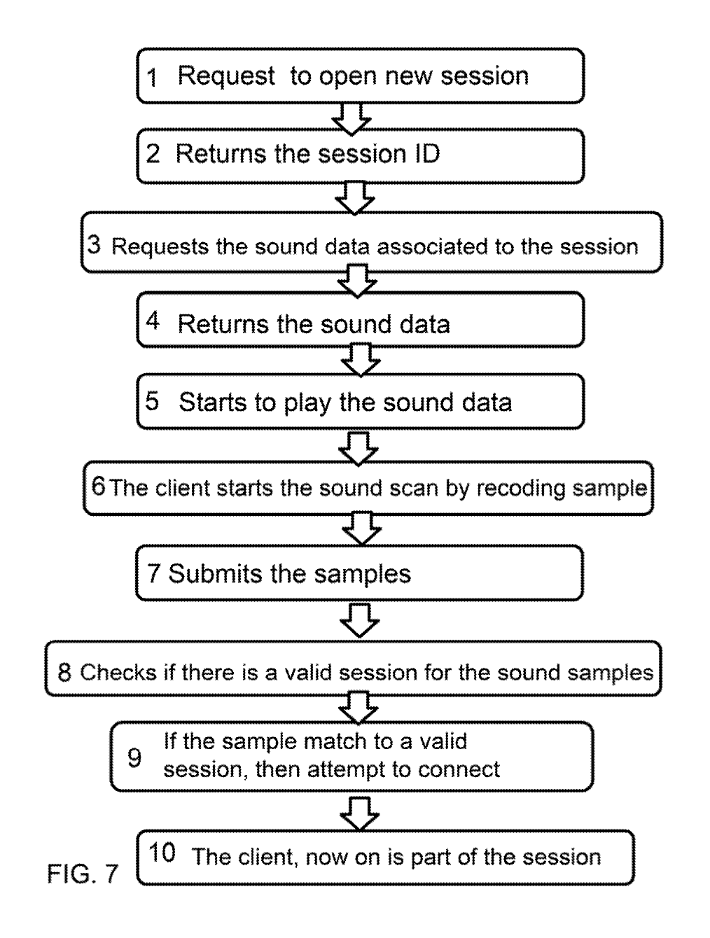

FIGS. 6-10 refer to one or more embodiments for a method of performing proximity verification for different types of computing devices, and also for an offline exchange of data. FIG. 6 is a pictorial illustration of a non-limiting embodiment of system that includes components that may be used in an exemplary proximity verification process, and is particularly directed to a proximity verification process involving all computing devices, except for a feature phone. FIG. 7 is a flowchart of an exemplary process for performing proximity verification for the computing devices of FIG. 6. The steps shown in FIG. 6 are described in the flow chart in FIG. 7.

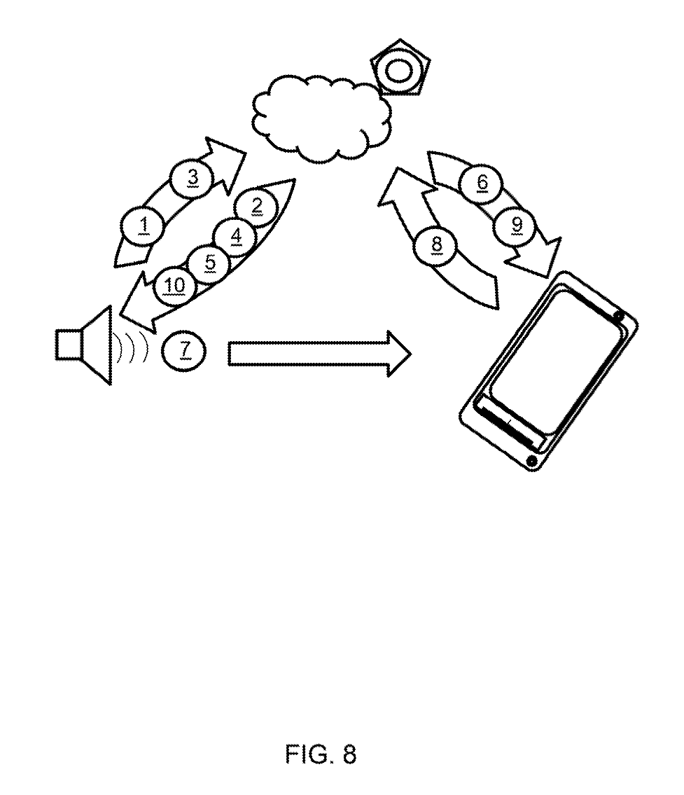

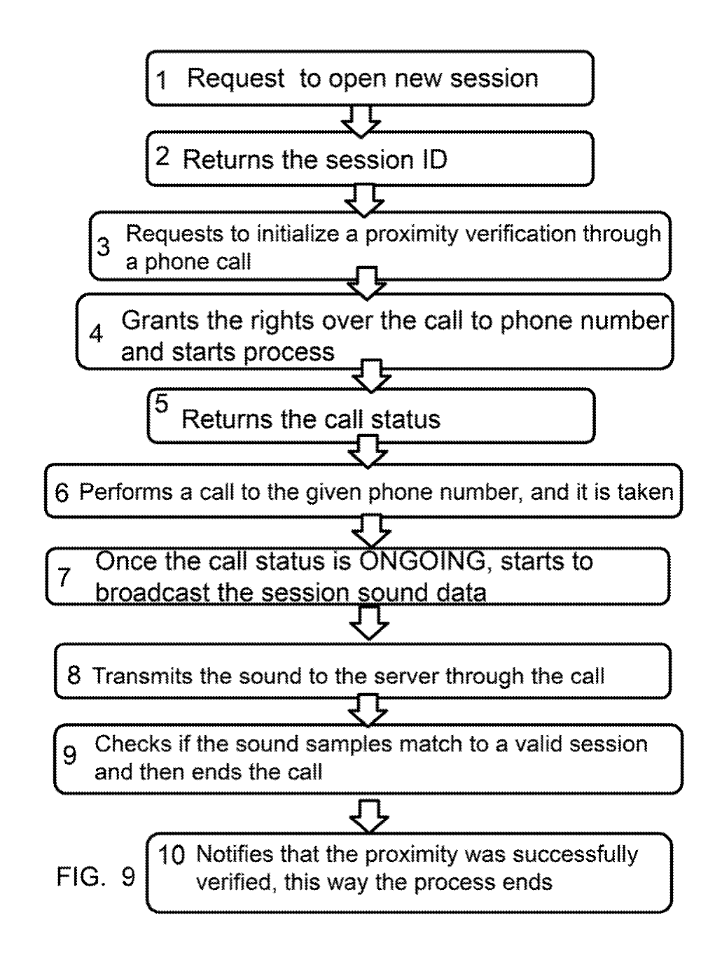

FIG. 8 is a pictorial illustration of a non-limiting embodiment of a system that includes components that may be used in an exemplary proximity verification process, and is particularly directed to a proximity verification process involving a computing device that is a feature phone. FIG. 9 is a flowchart of an exemplary process for performing proximity verification for the computing devices of FIG. 8, including a feature phone. Thus, it is an object of the present invention to include means for exchanging user profiles containing user contact information for smartphones, feature phones, and a myriad of other types of computing devices already described above. The steps shown in FIG. 8 are described in the flow chart in FIG. 9.

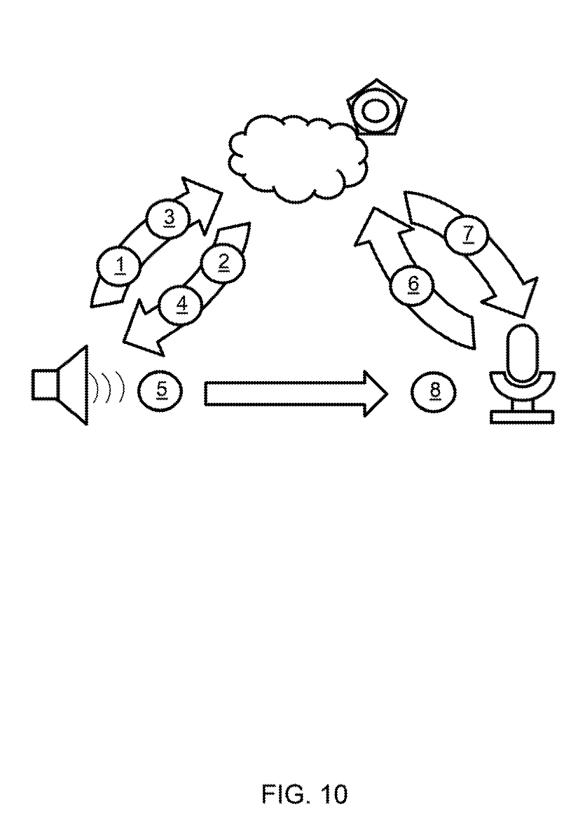

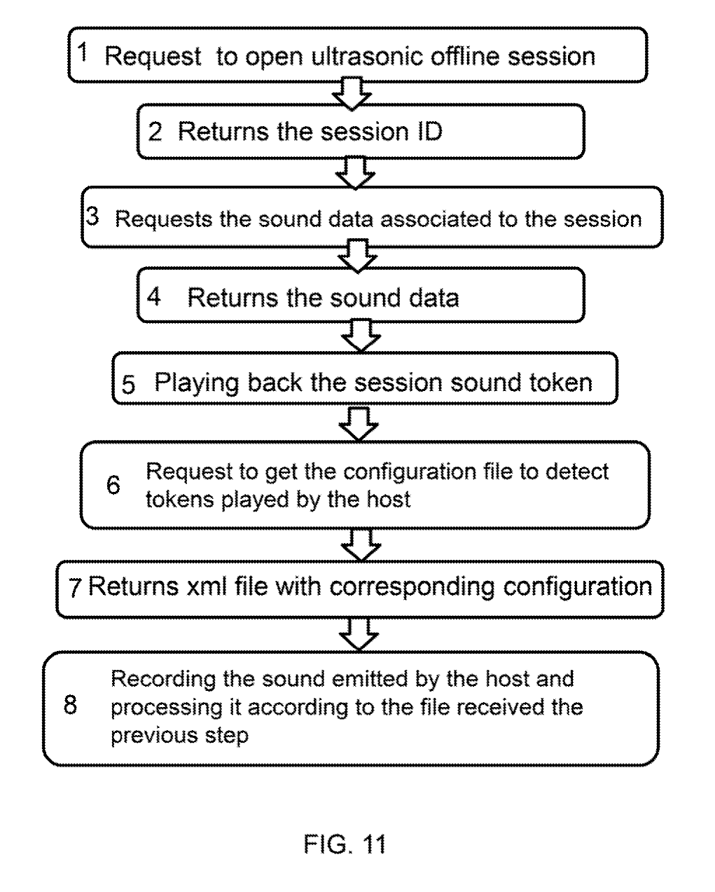

FIG. 10 is a pictorial illustration of a non-limiting embodiment of a system that includes components that may be used in an exemplary proximity verification process for an offline exchange of contact information. FIG. 11 is a flowchart of an exemplary process for the offline exchange of contact information for the components of the system in FIG. 10. (more description will be provided about FIGS. 5-11 in second draft) The steps shown in FIG. 10 are described in the flow chart in FIG. 11.

Turning now to FIG. 12, a pictorial illustration of is a pictorial illustration depicting an embodiment of a network environment is shown in accordance with an illustrative embodiment in accordance with one embodiment. FIG. 12 discloses a pictorial illustration depicting an embodiment of a network environment in accordance with an illustrative embodiment. FIG. 12 depicts a possible operating environment as well as associated system components (e.g., hardware elements) in connection with the methods and systems described herein. Referring to FIG. 12, an embodiment of a network environment 1200 is depicted.

In brief overview, the network environment 1200 includes one or more client devices, 1202, 1204, and 1206. Client devices 1202-1206 include a pictorial illustration of a Personal Computer (PC), Laptop. Tablet, and smart phone device. Clients 1202-1206 (also generally referred to as local machine(s), client(s), client node(s), client machine(s), client computer(s), client device(s), endpoint(s), or endpoint node(s)) in communication with one or more servers 1216, 1214, and 1218 (also generally referred to as server(s), node, or remote machine(s)) via one or more network(s) 1208. In some embodiments, a client, such as 1202, has the capacity to function as both a client node seeking access to resources provided by a server and as a server providing access to hosted resources for other clients 1202-1206.

Firewall 1210 is an application firewall and/or a hardware firewall between network 1208 and servers 1214-1218. Load balancer 1212 distributes workloads associated with clients 1202-1206 across multiple computing resources, such as servers 1214-1218.

Although FIG. 12 shows a network 1208 between clients 1202-1206 and servers 1214-1218, clients 1202-1206 and servers 1216-1218 may be on the same network 1208. The network 1208 can be a local-area network (LAN), such as a company Intranet, a metropolitan area network (MAN), or a wide area network (WAN), such as the Internet or the World Wide Web.

In some embodiments, there are multiple networks between clients 1202-1206 and the servers 1216-1218. In one of these embodiments, network 1208 may include both a private network and a public network. Network 1208 may be a private network or a public network.

The network 1208 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, network 1208 may comprise a wireless link, such as an infrared channel or satellite band. The topology of the network 1208 may be a bus, star, or ring network topology. The network 1208 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 1216-1218. In one of these embodiments, the logical group of servers may be referred to as a server farm or a machine farm. In another of these embodiments, the servers 1216-1218 may be geographically dispersed. In other embodiments, a machine farm may be administered as a single entity. In still other embodiments, the machine farm includes a plurality of machine farms. The servers 1216-1218 within each machine farm can be heterogeneous-one or more of the servers 1216-1218 or machines 1216-1218 can operate according to one type of operating system platform (for example purposes only, WINDOWS NT), while one or more of the other servers 1216-1218 can operate on or according to another type of operating system platform (e.g., Unix or Linux).

In one embodiment, servers 1216-1218 in the machine farm may be stored in high-density rack systems, along with associated storage systems, and located in an enterprise data center. In this embodiment, consolidating the servers 1216-1218 in this way may improve system manageability, data security, the physical security of the system, and system performance by locating servers 1216-1218 and high performance storage systems on localized high performance networks. Centralizing the servers 1216-1218 and storage systems and coupling them with advanced system management tools allows more efficient use of server resources.

The servers 1216-1218 of each machine farm do not need to be physically proximate to another server 1216-1218 in the same machine farm. Thus, the group of servers 1216-1218 logically grouped as a machine farm may be interconnected using a wide-area network (WAN) connection or a metropolitan-area network (MAN) connection. For example, a machine farm may include servers 1216-1218 physically located in different continents or different regions of a continent, country, state, city, campus, or room. Data transmission speeds between servers 1216-1218 in the machine farm can be increased if the servers 1216-1218 are connected using a local-area network (IAN) connection or some form of direct connection. Additionally, a heterogeneous machine farm may include one or more servers 1216-1218 operating according to a type of operating system, while one or more other servers 1216-1218 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

Management of the machine farm may be de-centralized. For example, one or more servers 1216-1218 may comprise components, subsystems and modules to support one or more management services for the machine farm. In one of these embodiments, one or more servers 1216-1218 provide functionality for management of dynamic data, including techniques for handling failover, data replication, and increasing the robustness of the machine farm. Each server 1216-1218 may communicate with a persistent store and, in some embodiments, with a dynamic store.

Server 1216-1218 may be a file server, application server, web server, proxy server, appliance, network appliance, gateway, gateway, gateway server, virtualization server, deployment server, SSL VPN server, or firewall. In one embodiment, the server 1216-1218 may be referred to as a remote machine or a node. In another embodiment, a plurality of nodes may be in the path between any two communicating servers.

The client(s) 1202-1206 and server 1216-1218 may be deployed as and/or executed on any type and form of computing device, such as a computer, network device or appliance capable of communicating on any type and form of network and performing the operations described herein.

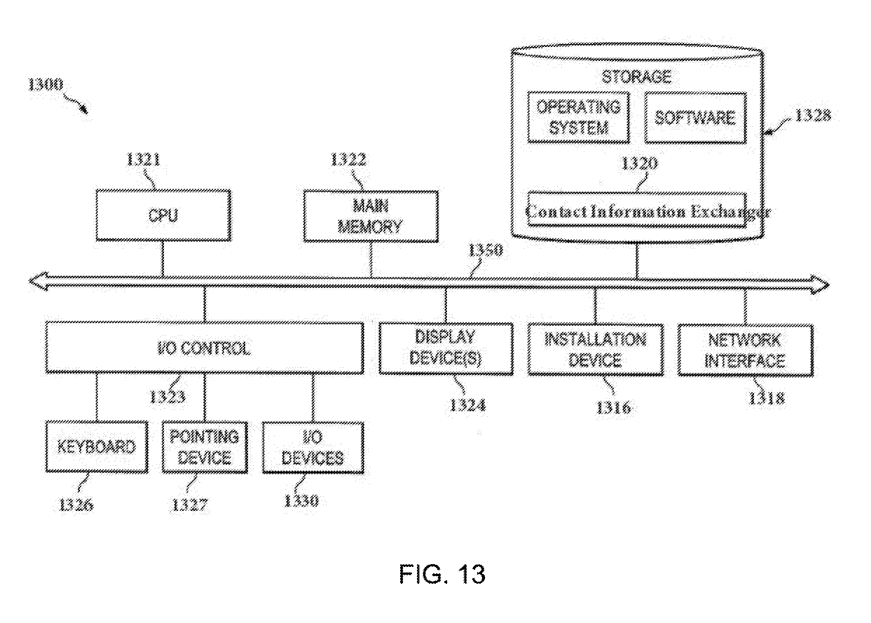

Turning to FIG. 13, FIG. 13 is a pictorial illustration of a computing device 1300 useful for practicing embodiments of the systems and methods described above. In addition, computing device 1300 may be a computing device in accordance with computing devices 101 and 140 shown in system 100 in FIG. 1. Further, computing devices 101 and 140 may include any one or all of the components shown in FIG. 13 in computing device 1300. In one or more embodiments, contact information exchanger 1320 shown in FIG. 13 is in accordance with contact information exchanger 114 as described herein and as shown above in FIG. 1.

Computing device 1300 includes a central processing unit (CPU) 1321, and a main memory unit 1322. Computing device 1300 may include a storage device 1328, an installation device 1316, and a network interface 1318, an I/O controller 1323, display device 1324, a keyboard 1326 and a pointing device 1327, such as a mouse. The storage device 1328 may include, without limitation, an operating system, software, and the contact information exchanger 1320 application. Each computing device 1300 may also include additional optional elements, such as a memory port, a bridge, one or more input/output devices 1330, and a cache memory in communication with the central processing unit 1321.

The central processing unit 1321 is any logic circuitry that responds to and processes instructions fetched from the main memory unit 1322. In many embodiments, the central processing unit 1321 is provided by a microprocessor unit. The computing device 1300 may be based on any of these processors, or any other processor capable of operating as described herein.

Main memory unit 1322 may be one or more memory chips capable of storing data and allowing any storage location to be directly accessed by the CPU 1321, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 1322 may be based on any of the above described memory chips, or any other available memory chips capable of operating as described herein. The CPU 1321 communicates with main memory 1322 via a system bus. CPU 1321 communicates directly with main memory 1322 via a memory port. For example, the main memory 1322 may be DRDRAM.

Main processor 1321 may communicate directly with a cache memory via a secondary bus, sometimes referred to as a backside bus. In other embodiments, the main processor 1321 communicates with cache memory using the system bus. The cache memory typically has a faster response time than main memory 1322 and is typically provided by SRAM, BSRAM, or EDRAM. The processor 1321 communicates with various I/O devices 1330 via a local system bus. Various buses may be used to connect the central processing unit 1321 to any of the I/O devices 1330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device 1330 is a video display, the processor 1321 may use an Advanced Graphics Port (AGP) to communicate with the display.

In another embodiment of computing device 1300, the main processor 1321 communicates directly with I/O device 1430 via HYPERTRANSPORT, RAPIDIO, or INFINIBAND communications technology. Another embodiment in which local busses and direct communication are mixed: the processor 1321 communicates with I/O device 1330 using a local interconnect bus while communicating with I/O device 1330 directly.

A wide variety of I/O devices 1330 may be present in the computing device 1300. User interface 106 shown in FIG. 1 may include elements of I/O devices 1330. Input devices include keyboards, mice, trackpads, trackballs, microphones, dials, drawing tablets, touch, finger gestures, and/or body gestures or voice gestures (e.g. SIRI). Output devices include video displays, speakers, inkjet printers, laser printers, and dye-sublimation printers. The I/O devices may be controlled by an I/O controller 1323 as shown in FIG. 13. The I/O controller may control one or more I/O devices such as a keyboard 1326 and a pointing device 1327, e.g., a mouse or optical pen. Furthermore, an I/O device may also provide storage and/or an installation medium 1316 for the computing device 1300. In still other embodiments, the computing device 1300 may provide USB connections (not shown) to receive handheld USB storage devices such as USB Flash Drive line of devices.

The computing device 1300 may support any suitable installation device 1316, such as a floppy disk drive for receiving floppy disks such as 3.5-inch, 5.25-inch disks or ZIP disks, a CD-ROM drive, a CD-R/RW drive, a DVD-ROM drive, Blu-ray DVD drive, a flash memory drive, tape drives of various formats. USB device, hard-drive or any other device suitable for installing software and programs. The computing device 1300 may further comprise a computer readable storage device, such as one or more hard disk drives or redundant arrays of independent disks, for storing an operating system and other related software, and for storing application software programs such as any program related to the software 1320 for the contact information exchanger application. Optionally, any of the installation devices 1316 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 1300 may include a network interface 1318 to interface to the network through a variety of connections including, but not limited to, standard telephone lines, LAN or WAN links (e.g., 802.11, T1, T3, 56 kb, X.25, SNA, DECNET), broadband connections (e.g., ISDN, Frame Relay. ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11B, IEEE 802.11g, CDMA, GSM, WiMax and direct asynchronous connections). In one embodiment, the computing device 1300 communicates with other computing devices 1300 via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 1318 may comprise a built-in network adapter, network interface card, PCMCIA network card, card bus network adapter, wireless network adapter, USB network adapter, modem or any other device suitable for interfacing the computing device 1300 to any type of network capable of communication and performing the operations described herein.

In some embodiments, the computing device 1300 may comprise or be connected to multiple display devices 1324, which each may be of the same or different type and/or form. As such, any of the I/O devices 1330 and/or the I/O controller 1323 may comprise any type and/or form of suitable hardware, software, or combination of hardware and software to support, enable or provide for the connection and use of multiple display devices 1324a-1324n by the computing device 1300. For example, the computing device 1300 may include any type and/or form of video adapter, video card, driver, and/or library to interface, communicate, connect or otherwise use the display devices 1324. In one embodiment, a video adapter may comprise multiple connectors to interface to multiple display devices 1324. In other embodiments, the computing device 1300 may include multiple video adapters, with each video adapter connected to one or more of the display devices 1324. In some embodiments, any portion of the operating system of the computing device 1300 may be configured for using multiple displays 1324. In other embodiments, one or more of the display devices 1324 may be provided by one or more other computing devices, for example, via a network. These embodiments may include any type of software designed and constructed to use another computer's display device as a second display device 1324 for the computing device 1300. One ordinarily skilled in the art will recognize and appreciate the various ways and embodiments that a computing device 1300 may be configured to have multiple display devices 1324.

In further embodiments, an I/O device 1330 may be a bridge between the system bus 1350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 1300 of the sort depicted in FIG. 13 typically operates under the control of operating systems, which control scheduling of tasks and access to system resources. The computing device 1300 can be running any operating system available to one of ordinary skill such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS VISTA, WINDOWS 7, and WINDOWS 8.1, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 1300 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computing device 1300 has sufficient processor power and memory capacity to perform the operations described herein. For example, the computing device 1300 may comprise a device of the IPOD, IPHONE, IPAD, or APPLE TV family of devices manufactured by Apple Computer of Cupertino, Calif.

In some embodiments, the computing device 1300 may have different processors, operating systems, and input devices consistent with the device. For example, in one embodiment, the computing device 1300 may be any type of smart phone belonging to a user. An example of smart phone includes, but is not limited to, any generation of IPHONE smart phone, which is manufactured by Apple, Inc. In some of these embodiments, the IPHONE is operated under the control of the iOS operating system and includes systems and methods for touch input device. In other embodiments, the computing device may be a smart phone operated under the control of the GOOGLE ANDROID operating system. The user may utilize any type of smart phone and necessary operating system to actively utilize the smart phone.

In other embodiments, the computing device 1300 is a mobile device, such as a JAVA-enabled cellular telephone or personal digital assistant (PDA). In some embodiments, the computing device 1300 is a mobile device manufactured by Nokia of Finland, or by Sony Ericsson Mobile Communications AB of Lund, Sweden.

In still other embodiments, the computing device 1300 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 1300 is a smart phone, Pocket PC, Pocket PC Phone, or other handheld mobile device supporting Microsoft Windows Mobile Software. Moreover, the computing device 1300 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 1300 is a digital audio player, and may be any type of digital audio player known to one of ordinary skill in the art. In one of these embodiments, the computing device 1300 is a digital audio player such as the Apple IPOD, IPOD Touch, and IPOD NANO lines of devices, manufactured by Apple Computer of Cupertino, Calif. In another of these embodiments, the digital audio player may function as both a portable media player and as a mass storage device.

In some embodiments, the communications device includes a combination of devices, such as a mobile phone combined with a digital audio player or portable media player. In one of these embodiments, the communications device is a smart phone, for example, an iPhone manufactured by Apple Computer, or a Blackberry device, manufactured by Research In Motion Limited. In yet another embodiment, the communications device is a laptop or desktop computer equipped with a web browser and a microphone and speaker system, such as a telephony headset. In these embodiments, the communications devices are web-enabled and can receive and initiate phone calls. In other embodiments, the communications device is a Motorola RAZR or Motorola ROKR line of combination digital audio players and mobile phones.

In some embodiments, the status of one or more machines in the network is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

Advantageously, one or more embodiments of the systems and methods described above may provide for the sending and receiving of secured encrypted data between two devices using sound waves. Beneficially, as a result of the illustrative embodiments provided above, computing devices, including mobile smartphones, are able to exchange information related to a user's contact information and social media accounts without compatibility issues, because the transfer of this digital data is essentially achievable through audio hardware (e.g. microphones and speakers). This type of audio hardware is usually present in the vast majority of smartphones, tablets, laptops, and other types of computing devices or are easily added or attached to these devices. Accordingly, the novel and unique aspects provided for in the present description allow for a user's contact information, including social media account information, to be exchanged with the added benefits of speed, because transfer of data via sound has been shown to have an increased bitrate. Further, this method of transfer may be more secure and difficult for a malicious actor to de-code or reverse engineer. Additionally, the system and methods provided herein in one or more embodiments have been shown to have limited battery power consumption, in particular when comparing the battery power consumption required to pair devices via BLUETOOTH. Accordingly, the one or more embodiments described herein offer numerous advantages and benefits over the existing methods for exchanging contact information.

The description of the present invention has been presented for purposes of illustration, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. Thus, the description is to be regarded as illustrative instead of restrictive on the present invention. The present invention may be practiced with modification and alteration within the spirit and scope of the appended claims.

What is claimed is:

1. A secure method of transferring profile data comprising the steps of:
a. providing a transmitting mobile electronic device comprising:
i. a computing system;
ii. transmitter profile data;
iii. a transmitter speaker,
iv. a transmitter data storage
b. providing a receiving mobile electronic device;
i. a computing system;
ii. a receiver microphone;
iii. a receiver data storage;
wherein the transmitter profile data is transmitted via acoustical waves within the ultrasonic range produced by the transmitter speaker to the receiver microphone, and wherein the transmitter profile data is stored in the receiver data storage.

2. The secure method of transferring profile data of claim 1, wherein the ultrasonic waves have a frequency of between 16 kHz and 1 GHz.

3. The secure method of transferring profile data of claim 1, wherein the transmitter profile data comprises a transmitter name and a transmitter telephone number.

4. The secure method of transferring profile data of claim 1, wherein the transmitter profile data comprises a transmitter email address.

5. The secure method of transferring profile data of claim 1, wherein the transmitter profile data comprises at least one of a transmitter social media identification.

6. The secure method of transferring profile data of claim 1, wherein the transmitter profile data comprises a transmitter resource locators (“URLs).

7. The secure method of transferring profile data of claim 1, wherein the receiving mobile device comprises a receiver speaker that produces a sound token when the transmitter profile data is received by the receiving mobile device.

8. The secure method of transferring profile data of claim 1, wherein transmitter speaker produces a sound token when the transmitter profile data is received by the receiving mobile device. Sound token in the audible range 16 Hz and 20 kHz.

9. The secure method of transferring profile data of claim 1, transmitting mobile electronic device and the receiving mobile electronic device is selected from the group consisting of: cellular phone, laptop computer and tablet computer.

10. A secure method of transferring profile data of claim 1, wherein the transmitting mobile electronic device further comprises a transmitter speaker and wherein the receiving mobile electronic device further comprises a receiver microphone and a receiver data profile; and wherein the receiving electronic device simultaneously transmits receiver profile data via acoustical waves produced by the receiver speaker to the transmitter microphone while said transmitter profile data is transmitted to the receiver mobile electronic device, and wherein the receiver profile data is subsequently stored in the transmitter data storage.

11. The secure method of transferring profile data of claim 1, wherein said acoustical waves produced by transmitter and receiver mobile electronic devices has a frequency of between 18 khz and 21 khz.

12. The secure method of transferring profile data of claim 1, wherein the bitrate of the transmitter profile data transmission is above 3.6 kbps.

13. The secure method of transferring profile data of claim 12, wherein the acoustical waves have a frequency band of 6 kHz to 20 kHZ.

14. The secure method of transferring profile data of claim 1, wherein the transmitting mobile electronic device and the receiving mobile electronic device each comprise a codec program that runs on the respective computing systems to compresses data on the transmitting mobile electronic device and decompresses received data on the receiving mobile electronic device to increase transmission of data transmitted by said acoustical waves.

15. The secure method of transferring profile data of claim 14, wherein the codec program is a Copsonic computer program.

16. The secure method of transferring profile data of claim 1, wherein the transmitting mobile electronic device comprises a software program and a user interface for the software program; wherein a transmitting user runs said software program on said transmitting mobile electronic device to initiate the transmission of said transmitter profile data.

17. The secure method of transferring profile data of claim 16, wherein the receiving mobile electronic device comprises a software program and a user interface for the software program; wherein a receiving user runs said software program on said receiving mobile electronic device to initiate the reception of said transmitter profile data.

18. The secure method of transferring profile data of claim 16, wherein the software program comprises a user input profile data subroutine, wherein said transmitting user inputs said transmitter profile data.

19. The secure method of transferring profile data of claim 18, wherein said transmitting user inputs a plurality of transmitter profile data sets.

20. The secure method of transferring profile data of claim 19, wherein one of said a plurality of transmitter profile data sets is a personal profile data set.

21. The secure method of transferring profile data of claim 19, wherein one of said a plurality of transmitter profile data sets is a professional profile data set.

22. The secure method of transferring profile data of claim 1, wherein the transmitting mobile electronic device comprises a software program and a user interface for the software program; wherein a transmitting user runs said software program on said transmitting mobile electronic device to initiate the transmission of said transmitter profile data; and wherein the receiving mobile electronic device comprises a software program and a user interface for the software program; wherein a receiving user runs said software program on said receiving mobile electronic device to initiate the reception of said transmitter profile data.

23. The secure method of transferring profile data of claim 22, wherein the software program interfaces with a cloud database.

24. The secure method of transferring profile data of claim 23, wherein the transmitter data profile is stored on a cloud database.
